(19) United States
(12) Patent Application Publication
(10) Pub. No.: US 2006/0141431 A1
(43) Pub. Date: Jun. 29, 2006

(54) Health game apparatus and method using vital signs

(75) Inventor: Min-Hwa Lee, Seoul (KR)

Correspondence Address: JENKENS & GILCHRIST, P.C., 901 15TH STREET N.W., SUITE 900, WASHINGTON, DC, 20005, US

(73) Assignee: Healthpia America, Palisades, NJ (US)

(21) Appl. No.: 11/356,045

(22) Filed: Feb. 17, 2006

Related U.S. Application Data
(63) Continuation of application No. PCT/KR03/01921, filed on Sep. 19, 2003.

(30) Foreign Application Priority Data
Sep. 19, 2003 (KR) WO 2005/020121 A1
Aug. 21, 2003 (KR) 10-2003-0058062

(51) Int. Cl. A63F 13/00; G09B 19/00; G01J 1/42; A63F 9/24

(52) U.S. Cl. 434/236; 463/1; 250/372

(57) ABSTRACT

A health game apparatus produces, as a numerical value, a quantized biological index associated with a biological function or state from an electrical signal measured by a sensor detecting a biological signal, and considers the produced biological index to progress a game. The health game apparatus can conveniently perform a data input as data is directly inputted from the sensor and allow health management to be interestingly and continuously achieved through a game element coupled to the health management. The health game apparatus allows a host computer to manage the produced biological index and to manage game progress according to data inputted from a plurality of health game apparatuses. Thus, the health game apparatus enables persons having the same health problem to naturally form a community and enables health management to be interestingly performed in addition to an interest in the game.

### TECHNICAL FIELD

The present invention relates to a game apparatus, and more particularly to a health game apparatus capable of being used to manage health of a user.

### BACKGROUND ART

In the specification, the term “health” represents a generic concept including disease, beauty, etc. Furthermore, the term “health management” represents a generic concept including disease-related management such as blood glucose management, blood pressure management, liver function management, kidney function management, etc. and beauty-related management such as obesity management, skin management, etc.

When organs such as the liver, the kidney, etc. are damaged, it is not easy to prevent the damaged organs from deteriorating further. Thus, patients must continuously pay attention to their bodies while moderately dieting or exercising and monitoring their body states. Similarly, there is an interest in reducing a person's weight and maintaining a non-smoking habit as well as the blood glucose management and the blood pressure management.

Patients can conveniently monitor their blood glucose levels using portable glucose meters. Further, they can conveniently monitor their blood pressure states through blood pressure monitors for use in a general home, or through advanced portable blood-pressure monitors for measuring blood pressure based on a speed of blood globules. In a case of reducing body weight, they can conveniently confirm their body states using an apparatus for measuring the amount of body fat using a bio-impedance analysis technique that is disclosed in Korean Patent Application No. 2002-0052994.

Health or beauty management may be continuously conducted through a monitoring or measurement operation. Furthermore, it is important that continuous stimulation be given to a user so that the user can perform rigid self-management according to the given continuous stimulation. The health or beauty management method is disclosed in “BACKGROUND OF THE INVENTION” of Korean Patent Publication No. 2002-54075 filed in name of Min-Hyuk Choi. According to technology disclosed in Korean Patent Publication No. 2002-54075, a diet program is interworked with an online game, and the online game is differently performed according to caloric intake and an amount of exercise inputted by the user.

This idea can improve diet management through interworking the diet management with an interesting online game. However, there is a problem in that the user must manually input data of food intake and hence the user feels inconvenience of the manual data input. This technology is limited to the diet program. When the online game associated with the above-described technology is compared with the existing online game, only types of data are different. Consequently, the online game associated with the diet management is not technically improved in comparison with the existing online game. In other words, the above-described technology is only one type of online game.

The inventor has studied portable biological measuring devices such as an ultrasound scanner, a glucose meter, a bio-impedance analysis device, etc. for a long time. As a result, it has been found that self-health management can be effectively performed if a measuring device coupled to an online or offline game can be appropriately implemented.

### DISCLOSURE OF THE INVENTION

Therefore, the present invention has been made in view of the above background, and it is one object of the present invention to provide a health game apparatus and method using the same, which can interestingly and continuously promote health management.

It is another object of the present invention to provide a health game apparatus and method using the same, which allows biological data necessary for health management to be conveniently inputted.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a health game system including health game apparatuses 10-1, 10-2 and 10-3 and a host computer 30 in accordance with the present invention;

FIG. 2 is a schematic block diagram illustrating the configuration of a health game apparatus in accordance with one embodiment of the present invention;

FIG. 3 is a schematic flow chart illustrating a processing operation performed by the health game apparatus and a host computer communicating with the health game apparatus in accordance with another embodiment of the present invention;

FIG. 4 is a schematic block diagram illustrating a health game apparatus in accordance with another embodiment of the present invention; and

FIG. 5 is a schematic flow chart illustrating a processing operation performed by the health game apparatus and a host computer communicating with the health game apparatus in accordance with another embodiment of the present invention.

### BEST MODE FOR CARRYING OUT THE INVENTION

In accordance with an embodiment of the present invention, the above and other objects can be accomplished by the provision of a health game apparatus serving as a terminal based on an online or offline operation, which can produce, as a numerical value, a quantized biological index associated with a biological function or state from an electrical signal measured by a sensor detecting a biological signal or vital sign, and consider the produced biological index to progress a game.

In accordance with the present invention, the health game apparatus can conveniently perform a data input as data is directly inputted from the sensor and allow health management to be interestingly and continuously achieved through a game element coupled to the health management.

In accordance with another embodiment of the present invention, a health game apparatus communicates with a host computer and the host computer manages a biological index produced from a measurement value. The host computer manages game progress according to data inputted from a plurality of health game apparatuses so that a game can be a multiparty game. The health game apparatus enables persons having the same health problem to naturally form a community and enables health management to be interestingly achieved in addition to an interest in a game.

In accordance with the present invention, the term “game” includes not only various games such as competition games, simulation games, etc. but also various contents having interesting elements such as Internet cafes, Internet meetings, etc.

Furthermore, the health game apparatus in accordance with the present invention allows users to form groups and its function can be extended to support a competition game between the groups. For example, where a user does not individually compete with another user but a user group competes with another user group in a game for reducing body weight, the spirit of teamwork within the group is naturally made to promote an active motive of reducing the body weight.

In accordance with another embodiment of the present invention, a game character is shown in a game, and the game character assigned on a user-by-user basis is differently displayed according to a measured biological index. For example, if the health management is successfully and continuously achieved during a predetermined time, a good color of the face or good dress is assigned to the game character. Otherwise, a bad color of the face or bad dress is assigned to the game character. Alternatively, if the health management is successfully and continuously achieved during a predetermined time, an item capable of being used in the game is assigned according to the degree of success, and hence a corresponding user having the assigned item can be in an advantageous position in the game.

In accordance with the present invention, the health game apparatus can give an incentive to users so that rigid health management is promoted, and can visually display health states of the users, such that the users can actively perform the health management.

Now, preferred embodiments of the present invention will be described in detail with reference to the annexed drawings so that those skilled in the art can easily understand the present invention.

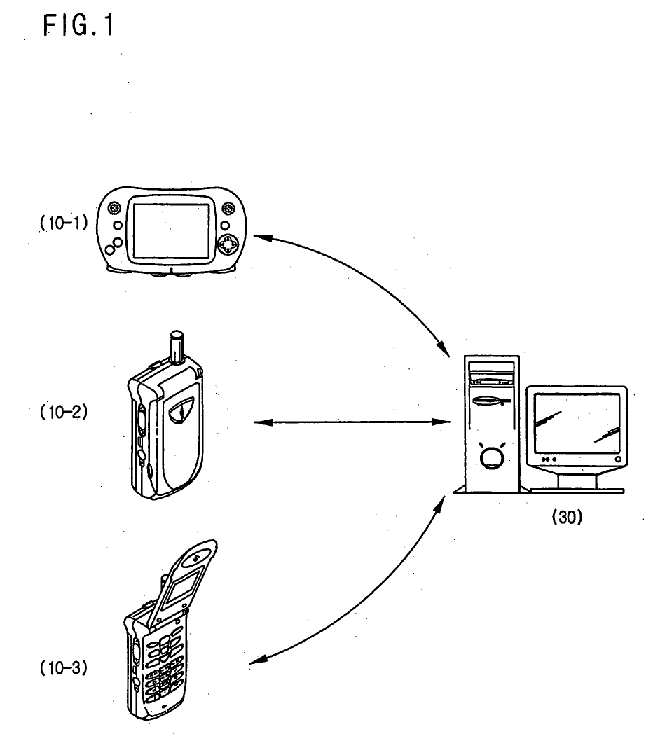

FIG. 1 is a schematic diagram illustrating a health game system including health game apparatuses 10-1, 10-2 and 10-3 and a host computer 30 in accordance with the present invention. The health game apparatuses 10-1, 10-2 and 10-3 and the host computer 30 communicate with each other through a data communication network such as a mobile communication network as an example. However, the present invention is not limited to the data communication network. In place of the data communication network, the present invention can employ an Internet network coupled over a wireless local area network (LAN) access point or a Bluetooth access point as another example.

In accordance with one embodiment of the present invention, the health game apparatuses 10-1, 10-2 and 10-3 are portable health game apparatuses equipped with sensors used for measuring health data. In accordance with another embodiment of the present invention, the health game apparatus can include, for example, a battery pack in which a sensor for inputting health data is embedded and a mobile-phone main body interfaced with the battery pack. For example, the battery pack includes a printed circuit board in which a glucose meter circuit is embedded. The printed circuit board performs a communication operation through a recommended standard (RS)-232 or universal serial bus (USB) interface provided in the mobile-phone main body. As other elements, four electrodes necessary for measuring bio-impedance and a measuring circuit are embedded in the battery pack, and a controller for controlling the circuit is interfaced with the mobile-phone main body. The health game apparatuses utilize user interfaces of the mobile phone such as a keypad, a liquid crystal display (LCD) and can provide various functions only through the replacement of the battery pack while reducing the economic burden.

The host computer 30 can be configured by one or more server computers. The host computer 20 includes a world wide web/Windows address book (WEB/WAB) server for processing user access, and a game progress sever interworked with the WEB/WAB server for progressing a game.

However, the present invention is not limited to the above-described server-based service. For example, the health game apparatus manages health data. Furthermore, the health game apparatus is interworked with the health data and can provide a game while considering biological data inputted from the sensor in real time.

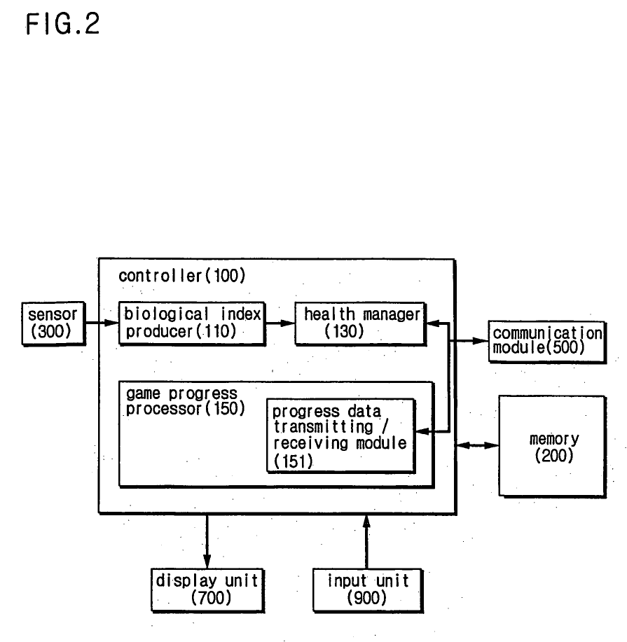

FIG. 2 is a schematic block diagram illustrating the configuration of a health game apparatus in accordance with one embodiment of the present invention. As shown in FIG. 2, the health game apparatus in accordance with the one embodiment of the present invention includes a memory 200 for storing a main program and data; a controller 100 for executing the main program stored in the memory 200 and controlling an overall operation of the health game apparatus; a sensor 300 for detecting a biological signal or vital sign; a display unit 700 for displaying game content and an operating state; and an input unit 900 for receiving a biological data value and an operation command from a user.

In accordance with the one embodiment of the present invention, the controller 100 is implemented by a microprocessor. The sensor 300 can detect various biological signals or vital signs indicating a blood glucose level, a pulse rate, blood pressure, blood flow, bio-impedance, etc. In this embodiment, the sensor 300 measures a blood glucose level and can be replaced as a one-time sensor. The sensor 300 includes an electrode strip on which a pair of working electrodes and a reference electrode surrounded by a biological film is printed and a measuring circuit for measuring electric voltage across the electrode strip after electric current is applied to the electrode strip. In accordance with the one embodiment of the present invention, the display unit 700 is a liquid crystal display (LCD). The display unit 700 displays a charging/discharging state of a battery serving as a power supply, displays operating modes classified into a charging mode, a standby mode, a measurement mode, a game mode, etc., and displays a measurement data screen, a stored data query screen, a game progress screen, etc. The input unit 900 includes a joystick, a trackball or direction keys necessary for progressing a game. The input unit 900 includes a keypad necessary for receiving an operation command and progressing the game.

The health game apparatus is a portable game apparatus not shown. The health game apparatus includes a battery and a power-supply stabilizing circuit. Where adopting a chargeable battery, the health game apparatus can further include a charging circuit.

In accordance with the present invention, the controller 100 includes a biological index producer for producing a quantized biological index associated with a biological function or state from a signal outputted by the sensor 300, and a game progress processor 150 for progressing a game according to a programmed game scenario in response to inputs of the produced biological index and the operation command.

In this embodiment, the biological index producer 110 digitally converts a signal value inputted from the sensor 300, i.e., a blood glucose measuring circuit, looks up a reference table, and produces a blood glucose level value. Since this operation is well known in relation to the conventional circuit and processing procedure provided in the existing blood glucose meter, a detailed description of the operation will be omitted.

The game progress processor 150 can process a competition game. The memory 200 stores a game program. The game program is executed so that the competition game based on several steps can be performed along with one or more virtual opposite parties. In this case, the user's character has different features according to blood glucose level values produced by the biological index producer 110. For example, a history of blood glucose levels measured on a user-by-user basis is stored and managed in the memory 200. If a blood glucose level value of the user is good in comparison with an average glucose level value, energy of the user's character is increased and the character is expressed as a very bright color. On the other hand, if a blood glucose level value of the user is not good during a predetermined time in comparison with the average glucose level value, the user's character is expressed as a dark color. At this time, the user's character is in a disadvantageous position since the energy of the user's character is decreased. In another embodiment of the present invention, a weapon used in the competition game by the user's character, i.e., an item, is assigned according to a biological index produced by the biological index producer 110, i.e., a one-time measurement value indicating a blood glucose level or an average value accumulated during a predetermined time. In other words, when the good blood glucose level of the user is maintained during a predetermined time, a very powerful item is assigned to the user, and the user is in an advantageous position in the competition game with virtual enemies.

When the game is progressed, the energy of the user's character can be interworked with a biological index in the form of an icon indicating the number. The energy of the user's character can be increased according to a game progress state or decreased where the user's character is damaged. For example, if the icon indicating an energy level is maintained as a good state of the blood glucose level, a kidney shape of a bright green color can be displayed. On the other hand, if the blood glucose level is in a bad state in comparison with a normal level, the kidney shape of a red color can be displayed.

In accordance with the present invention, the health game apparatus 10-1, 10-2 or 10-3 further includes a communication module 500 for communicating with a host computer through a network. The controller 100 further includes a health manager 130 for sending, to the host computer 30 through the communication module 500, biological state information after processing a biological index measured by the biological index producer 110 and a biological data value inputted through the input unit 900.

In accordance with this embodiment, the communication module 500 is a Bluetooth module, and is coupled to the Internet over a Bluetooth access point. The communication module 500 is not limited to the Bluetooth module. The communication module 500 can be a mobile communication modem for supporting communication with the host computer 30 over a mobile communication network.

The health manager 130 sends a measured biological index, i.e., visual data indicating a blood glucose level, and user identification information to the host computer 30. The host computer 30 stores received data in a database on a user-by-user basis, and monitors the stored received data. For example, the host computer 30 sends a result of a processing operation performed by a professional system and sends an electronic mail to the professional computer connected by an online form, such that the professional computer sends a received opinion of the electronic mail to the user periodically or in case of emergency. In the mobile communication network, a response can be sent in the form of a short message. In the Bluetooth network, a response can be sent by means of an electronic mail or a messenger since two-way communication can be performed.

In accordance with another embodiment of the present invention, the game progress processor 150 further includes a progress data transmitting/receiving module 151 for performing game progress data communication with an opposite party coupled to the host computer 30 through the communication module 500. In other words, in accordance with the present invention, the competition game is not performed between virtual characters provided from the program, but is performed between the user's character and an opposite party's character manipulated by another user of another health game apparatus connected over the network. Since this network-based game technology is well known, a detailed description of this network-based game technology will be omitted.

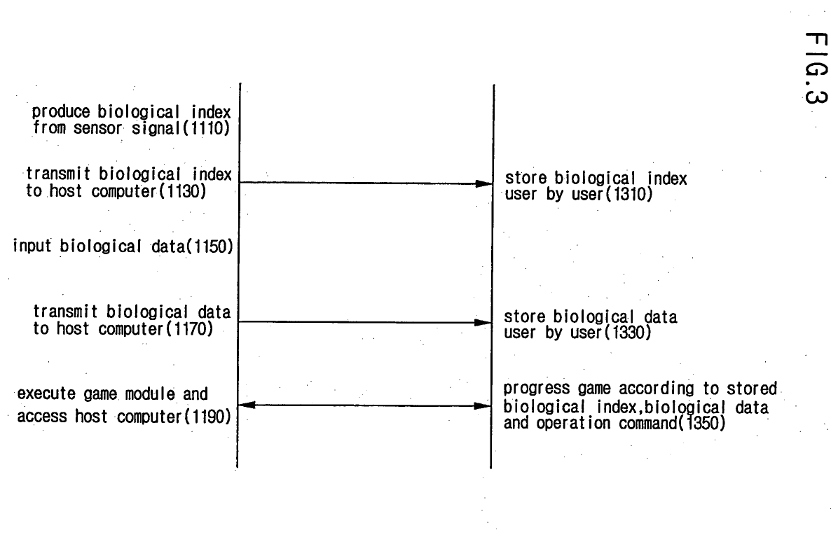

FIG. 3 is a schematic flow chart illustrating a processing operation performed by the health game apparatus and a host computer communicating with the health game apparatus in accordance with another embodiment of the present invention. As shown in FIG. 3, the health game apparatus produces a biological index and additionally performs a control operation for a graphic and a character in response to a control command from a server associated with game progress. The health game apparatus is used for a server-based game in which an operation for managing and controlling the game progress is performed by the host computer.

For example, the health game apparatus associated with obesity management will be described with reference to FIG. 3. As shown in FIG. 3, a method for processing health game data in accordance with the present invention produces a quantized biological index associated with a biological function or state from a signal inputted by the sensor embedded in the health game apparatus at step 1110. For example, this procedure converts a received bio-impedance measurement signal into digital data and converts the digital data into a value indicating an amount of fat in a body by means of a bio-impedance measuring circuit. In the bio-impedance measurement operation, bio-impedance is measured in a state where a plurality of electrodes are in contact with a specified part of the body of the user by means of a conductor. In accordance with one embodiment of the present invention, measurement points can be both hands.

Next, the game apparatus sends the produced biological index to the host computer at step 1130. A signal indicating a blood glucose level value is periodically transmitted to the host computer by the health game apparatus or can be transmitted in response to a request from the host computer. Then, the host computer stores a received biological index on a user-by-user basis at step 1310. The host computer manages the stored biological index on the user-by-user basis. For example, the host computer monitors a variation state associated with a blood glucose level value sent from a game terminal on the user-by-user basis. If an abrupt variation is present, the host computer can send a text message as an alarm message.

In accordance with the present invention, the game apparatus receives biological data from the input unit 900 to perform a game on the basis of the received biological data at step 1150. For example, a biological data value is directly interfaced with the terminal in an obesity management game. The biological data value can be a weight or height value that cannot be frequently measured. An obesity degree can be correctly confirmed by comparing the inputted weigh and height values with the measured bio-impedance value. The inputted biological data value is sent to the host computer at step 1170. The host computer stores and manages the biological data value on the user-by-user basis as in the biological index at step 1330.

Then, if the user selects one game from a menu provided from the health game apparatus of the user, the health game apparatus accesses the host computer for game progress at step 1190. Then, the host computer progresses the game while taking into account an operation command from the health game apparatus, a stored biological index and additional biological data at step 1350.

In other words, the host computer stores biological indexes on the user-by-user basis and organizes a database. The host computer controls the game progress using the biological indexes stored in the organized database. The health game apparatus controls an output of a graphic for a display unit or sound in response to a control command from the host computer.

For example, an obesity management game apparatus can be used for a cave adventure game. The user directly accesses the host computer or accesses the host computer over the network and progresses the game by fighting with monsters appearing in a cave in cooperation with other users joining the same game. At this time, a weapon or equipment for the game is provided as an item according to a game progress or biological index.

In accordance with the present invention, a form displaying the user's character joining the game can be different according to the produced biological index on the user-by-user basis. For example, the user's character is displayed in a fat form proportionate to the high obesity degree where the obesity degree of the user is high. A display control operation as a graphic processing operation can be easily implemented by those skilled in the art.

Additionally, in accordance with the present invention, a form of displaying the user's character for the game can be different according to biological data values stored in the host computer. In the case of the obesity management game, the character correctly indicates a current body state of the user, and the user can be stimulated through the character indicating the current body state and can feel the need for obesity management.

In accordance with the present invention, an item capable of being used in a game or a level of the game character is assigned or differently assigned according to the produced biological index or stored inputted biological data.

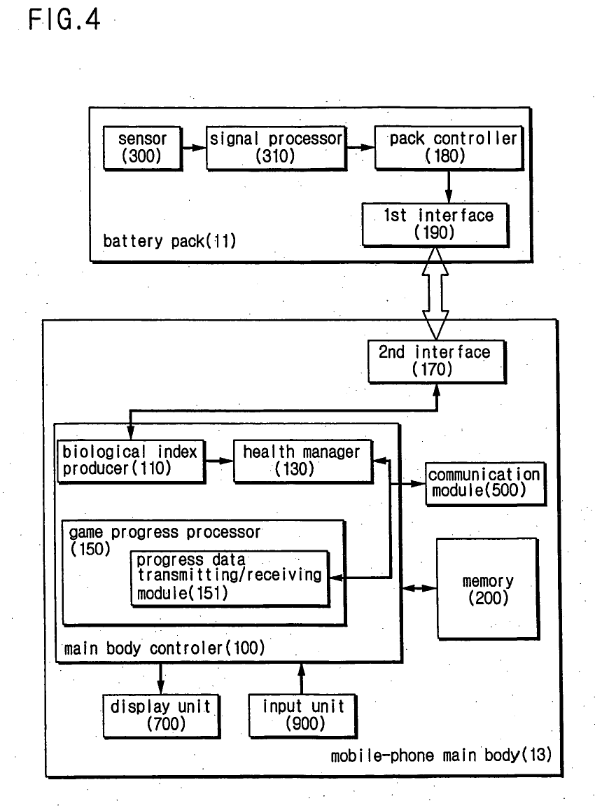

FIG. 4 is a schematic block diagram illustrating a health game apparatus in accordance with another embodiment of the present invention. An example of the health game apparatus includes a circuit for detecting a biological signal or vital sign in addition to the above-described battery pack of the mobile phone.

As shown in FIG. 4, a battery pack 11 in accordance with the embodiment of the present invention includes a signal processor 310 for performing pre-processing operations such as a filtering operation and an amplifying operation for an analog signal from the sensor and performing a digital conversion operation; the first interface 190 for performing data communication with the mobile-phone main body; and a pack controller 180 for controlling an overall operation of the health game apparatus.

In accordance with this embodiment, a sensor 300 includes four electrodes necessary for measuring bio-impedance. The signal processor 310 includes a constant-current drive circuit for supplying constant current to the four electrodes; a voltage measuring circuit for measuring voltage across the electrodes; an amplifying circuit; a filtering circuit; and an analog-digital conversion circuit for converting a filtered signal value into a digital value. The pack controller 180 communicates with the main body controller 100. Upon receiving a measurement initiation command, the pack controller 180 controls the signal processor 310 to measure bio-impedance and sends a measurement value of the bio-impedance to the mobile-phone main body through the first interface 190. In accordance with the embodiment, the first interface 190 is a USB interface. Alternatively, the first interface 190 can be directly connected to a USB interface of a signal jack for the mobile phone through a cable, and can be designed so that several terminals are added to an electrode coupled to the battery pack and the mobile-phone main body in a sliding manner and the several terminals can be in contact with the first interface 190.

The mobile-phone main body 13 includes a display unit 700, an input unit 900, a communication module 500, a memory 200, a main body controller 100 and the second interface 170. Since the display unit 700, the input unit 900, the communication module 500 and the memory 200 shown in FIG. 4 are identical to those shown in FIG. 2, and a configuration of the second interface 170 corresponds to that of the first interface 190, a description of those elements will be omitted. In addition to an operation of the controller 100 shown in FIG. 2, the main body controller 100 communicates with a battery pack 11. The main body controller 100 acquires biological signal data or vital sign data through the second interface 170 and outputs, to the second interface 170, command data for commanding measurement initiation according to a predetermined protocol.

In accordance with this embodiment, a game progress processor 150 is directly interfaced with a health manager 130. The game progress processor 150 can be implemented by various programs and can be downloaded from a computer coupled to a wireless Internet or a cable. An interface of a game module is standardized according to the type of data to be processed by the health manager 130. When the user selects the execution of a downloaded game program, for example, a corresponding game is executed on the basis of a virtual machine of the mobile phone. A biological index producer 110 and the health manager 130 are provided as independent application programs, and are selectively mounted according to a type of the battery pack 11. In accordance with the preferred embodiment, the application programs configuring the biological index producer 110 and the health manager 130 are downloaded from the battery pack 11 through the second interface, stored in a specified area of the main body 13 so that the application programs stored in the specified area of the main body 13 can be executed.

A method for processing health game data in accordance with another embodiment of the present invention includes the steps of: producing a quantized biological index associated with a biological function or state from a signal inputted by a sensor provided in a health game apparatus; allowing the game apparatus to send the produced biological index to a host computer and to store the produced biological index on a user-by-user basis; allowing the health game apparatus to access the host computer in response to a game selected by a user; allowing the host computer to receive and disclose request information for joining a group from the user and to process participation requests from game members to configure groups; allowing the host computer to select an opposite group from the configured groups; and allowing the host computer to progress the game according to the biological index stored on the user-by-user basis and an operation command from the health game apparatus.

Preferably, the method for processing the health game data can further include the step of: making an agreement for a game progress rule between groups joining the game.

Preferably, the method for processing the health game data can further include the step of: giving notification indicating a game progress state to members belonging to the groups.

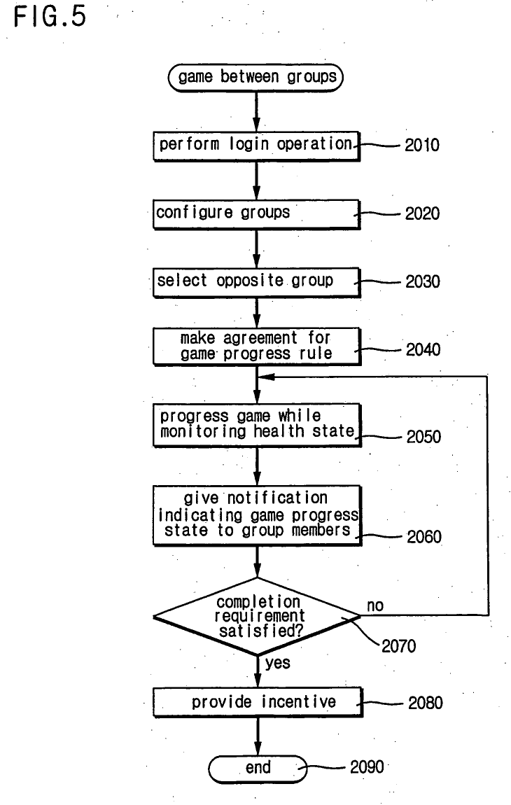

FIG. 5 is a schematic flow chart illustrating a method for processing health game data performed by a server serving as a host computer and a game client mounted in a terminal in accordance with another embodiment of the present invention. In accordance with this embodiment, a plurality of users configure groups, and a game is progressed in the form of a competition between groups. The method for processing the health game data will be described in detail with reference to FIG. 5.

First, users individually perform a login operation to access the host computer at step 2010. When one of the users selects a group generation menu item, the host computer configures a new group, designates a leader of the group and stores information associated with the new group and its leader in a database at step 2020. Then, notice of the new group is given, for example, by posting to a bulletin board, and the group leader advertises his or her own group through detailed content of the bulletin board. In the login state, new users read group advertisement content of the bulletin board and select groups to participate in. In terms of special requirements on a group-by-group basis, a current weight and height and a range of body fat measured from bio-impedance can be limited in the case of a weight reduction game.

If group members arrive at the predetermined number, a group formation is completed. Any group member cannot arbitrarily withdraw from the group if the group is formed as a characteristic of the game. The group leader listens to opinions from the group members and proposes the game to other groups. At this time, a plurality of games can be provided between the groups, and one of the games is selected. When the group selects one of other groups and the one of other groups accepts the selection, the selected group is set as an opposite group at step 2030.

At this time, an agreement for a detailed game progress rule is made at step 2040. For example, if notification indicating a sum of weights of all group members is made and a target weight sum is set, a time limit necessary for arriving at the target weight sum is designated. A victory or defeat in the game is basically determined according to whether or not the target weight sum is achieved within the time limit. A degree of game participation of the group members can be expressed as a numerical value. For example, an area of a city is assigned to each member in a city construction game and the city can be uniquely constructed on an area-by-area basis. Furthermore, a target can be to optimally construct a road network and a communication network through mutual communication. At this time, the city constructed by a road simulation operation and a communication simulation operation can be evaluated in real time. Furthermore, a game score is calculated according to a ratio of buildings and spaces, the number of members joining the city construction game, a result of a defense operation against an assault for destroying an opposite city, etc. Since the above-described game is well known, a detailed description of the game will be omitted.

On the other hand, if users perform a login operation to access the host computer and select an item of a corresponding group game menu, a current game progress state is displayed. At this time, a user's weight and an amount of body fat are displayed on one side of a top area of the display unit, and a current weight sum, a target weight sum and an average body-fat amount associated with a group to which the user belongs are displayed on the other side of the top area of the display unit. Current weight values and fat amounts of the members are disclosed according to the user's selection, and a short message as an encouragement message can be sent to the group's members who are far away from their target values. An operation for exchanging the message is performed through a server, and the exchanged message can be reflected in the game score.

In the case of the city construction game, an area of the city assigned to a user is indicated on a screen and game progress states of other users are monitored on the screen. The user selects construction materials and performs a construction operation at step 2050. A game client performs a graphic processing operation and sends a data value indicating a result of the processing operation to the host computer. The host computer can receive the data value, organize a database storing information of an entire construction state and perform a synchronization operation associated with the game progress state. The synchronized game progress state can be periodically known to other members and confirmed at step 2060.

The host computer determines whether a predetermined score is obtained or a completion requirement is satisfied at step 2070. If the completion requirement is satisfied, the host computer searches for a winner group in the game competition and a best member of the winner group so that incentive such as congratulation messages, gifts, etc. is provided to the winner group and the best member of the winner group at step 2080. Then, the game is terminated at step 2090.

### INDUSTRIAL APPLICABILITY

As apparent from the above description, the present invention provides a health game apparatus and method using the same, which can provide a communication function to portable medical equipment for measuring a biological signal or vital sign associated with disease and beauty, execute a downloaded game program on the basis of measured biological data, such that continuous interest and stimulation in managing a user's health can be promoted.

Further, the present invention simplifies a data input operation in comparison with the conventional game apparatus, such that a user allows data to be easily and conveniently inputted.

Furthermore, the present invention allows persons having a similar disease or beauty problem to enjoy an online game, to exchange information over the same virtual space and to form a community through the promotion of close relations.

Still furthermore, the present invention allows the user's health state to be expressed as a character or icon and allows the user's health state to be shown to other users, such that health care can be further promoted.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. A health game apparatus, comprising:
a sensor for detecting a biological signal;
an input unit for receiving an operation command from a user;
a controller comprising a biological index producer for producing, as a numerical value, a quantized biological index associated with a biological function or state on the basis of the biological signal detected by the sensor; and a game progress processor for progressing a game according to a programmed game scenario in response to the produced biological index and the operation command; and
a display unit for displaying game content and an operating state.

2. The health game apparatus as set forth in claim 1, further comprising:
a communication module for communicating with a host computer over a network,
wherein the controller further comprises:
a health manager for sending, to the host computer through the communication module, biological state information indicating a result of a processing operation for the biological index measured by the biological index producer and a biological data value inputted through the input unit.

3. The health game apparatus as set forth in claim 2, wherein the game progress processor comprises:
a progress data transmitting/receiving module for performing game progress data communication with an opposite party coupled to the host computer through the communication module.

4. The health game apparatus as set forth in claim 1, wherein the game progress processor additionally progresses the game according to a biological data value inputted through the input unit.

5. A method for processing health game data, comprising the steps of:
(a) producing a quantized biological index associated with a biological function or state from a signal inputted by a sensor provided in a health game apparatus;
(b) allowing the game apparatus to send the produced biological index to a host computer and to store the produced biological index on a user-by-user basis;
(c) allowing the health game apparatus to access the host computer in response to a game selected by a user; and
(d) allowing the host computer to progress the game according to the biological index stored on the user-by-user basis and an operation command from the health game apparatus.

6. The method as set forth in claim 5, further comprising the steps of:
(e) allowing the game apparatus to receive a biological data value from an input unit provided in the health game apparatus and to transmit the received biological data value to the host computer; and
(f) allowing the host computer to store the biological data value on the user-by-user basis,
wherein the step (d) is carried out by progressing the game according to the stored biological data value in addition to the biological index and the operation command.

7. The method as set forth in claim 5, wherein the step (d) comprises the step of:
differently displaying a game character of a corresponding user on the user-by-user basis according to the produced biological index.

8. The method as set forth in claim 6, wherein the step (d) comprises the step of:
differently displaying a game character of a corresponding user on the user-by-user basis according to the produced biological index or the received biological data value.

9. The method as set forth in claim 5, wherein the step (d) comprises the step of:
assigning an item capable of being used in the game or differently assigning a level of a game character according to the produced biological index.

10. The method as set forth in claim 6, wherein the step (d) comprises the step of:
assigning an item capable of being used in the game or differently assigning a level of a game character according to the produced biological index or the received biological data value.

11. A health game apparatus, comprising:
a battery pack comprising a sensor for detecting a biological signal, a signal processor for pre-processing an analog signal from the sensor and converting the analog signal into a digital signal; a first interface for performing data communication with a mobile-phone main body; and a pack controller for controlling an overall operation of the health game apparatus;
a second interface coupled to the first interface;
an input unit for receiving an operation command from a user;
a display unit for displaying game content and an operating state;
a main body controller for outputting command data for commanding measurement initiation to the second interface on the basis of a predetermined protocol, the main body controller comprising a biological index producer for producing, as a numerical value, a quantized biological index associated with a biological function or state from data inputted through the second interface; and a game progress processor for progressing a game according to a programmed game scenario in response to the produced biological index and the operation command; and
the mobile-phone main body capable of being coupled to or removed from the battery pack.

12. The health game apparatus as set forth in claim 11, further comprising:
a communication module communicating with a host computer over a network,
wherein the controller further comprises:
a health manager for sending, to the host computer through the communication module, biological state information indicating a result of a processing operation for the biological index measured by the biological index producer and a biological data value inputted through the input unit, and
wherein the game progress processor comprises:
a progress data transmitting/receiving module for performing game progress data communication with an opposite party coupled to the host computer through the communication module.

13. The health game apparatus as set forth in claim 12, wherein the biological index producer and the health manager are configured by one application program, respectively.

14. The health game apparatus as set forth in claim 13, wherein the game progress processor is downloaded from the host computer as one application program and is installed on the basis of the one application program.

15. A method for processing health game data, comprising the steps of:
(a) producing a quantized biological index associated with a biological function or state from a signal inputted by a sensor provided in a health game apparatus;
(b) allowing the game apparatus to send the produced biological index to a host computer and to store the produced biological index on a user-by-user basis;
(c) allowing the health game apparatus to access the host computer in response to a game selected by a user;
(d) allowing the host computer to receive and disclose request information for joining a group from the user and to process participation requests from game members to configure groups;
(e) allowing the host computer to select an opposite group from the configured groups; and
(f) allowing the host computer to progress the game according to the biological index stored on the user-by-user basis and an operation command from the health game apparatus.

16. The method as set forth in claim 15, further comprising the step of:
(g) making an agreement for a game progress rule between groups joining the game.

17. The method as set forth in claim 15, further comprising the step of:
(h) giving notification indicating a game progress state to members belonging to the groups.

18. The health game apparatus as set forth in claim 2, wherein the game progress processor additionally progresses the game according to a biological data value inputted through the input unit.

19. The method as set forth in claim 7, wherein the step (d) comprises the step of:
assigning an item capable of being used in the game or differently assigning a level of a game character according to the produced biological index.

20. The method as set forth in claim 8, wherein the step (d) comprises the step of:
assigning an item capable of being used in the game or differently assigning a level of a game character according to the produced biological index or the received biological data value.
